(19) United States
(12) Patent Application Publication
(10) Pub. No.: US 2026/0276185 A1
(43) Pub. Date: Sep. 17, 2026

(54) T-GRID HANGER BAR ELECTRONICS MOUNTING BRACKET ASSEMBLY

(71) Applicant: SIGNIFY HOLDING B.V., Eindhoven (NL)

(72) Inventors: Andrew L. ROBOTA, Senoia, GA (US); Jacob WATFORD, Sharpsburg, GA (US)

(21) Appl. No.: 19/549,447

(22) Filed: Feb. 25, 2026

Related U.S. Application Data
(60) Provisional application No. 63/771,380, filed on Mar. 13, 2025.

(30) Foreign Application Priority Data
Mar. 27, 2025 (EP) 25166690.5

(51) Int. Cl. F21V 21/088; F21S 8/04; F21V 23/00

(52) U.S. Cl. CPC F21V 21/088; F21S 8/043; F21V 23/003

(57) ABSTRACT

The invention relates to a device and method for a T-grid hanger bar mounting bracket assembly for luminaire electrical components including a two or more brackets with a clip on a single T-grid hanger bar. A platform configured above the two or more brackets. The clip includes two prongs that attaches to or is inserted on top of the T-grid hanger bar. A fastener extending through at least the one prong of the clip and engages the grid hanger bar to secure the two or more brackets to the grid hanger bar. The mounting bracket assembly further comprises a platform supported by the bracket, wherein the platform include a plurality of electronic component attachment points.

### FIELD OF THE INVENTION

The invention relates to a device and method for providing a T-grid hanger bar mounting bracket assembly for luminaire electronics or driver having a bracket, a clip, a fastener extending through at least a portion of the clip to secure the bracket to the T-grid hanger bar and a platform supported by the bracket, wherein the platform has a plurality of electronic component attachment points.

### BACKGROUND

LED light sources have decreased size relative to other light sources to such an extent that the electronic components required to run the light sources are the constraining factors in fixture design. In addition, many different electrical options are needed with various light fixtures, and these electric options can be very large which require the fixture to grow.

By removing the electronics from the fixture, the designer is granted freedom to make smaller fixtures. The issues presented are what to do with the electronics, how they are installed, and how they are maintained.

With the electronics now being remote, there needs to be a means for them to be maintained and accessed once they've been installed. Additionally, due to the variability in ceiling type, there must be a means to have the remote electronics installed in ceilings.

Inevitably electronics meet a point in service life where they retire or fail and need to be replaced, or the user requests a change and they need to be accessed to deploy that change. Luminaires or LED lighting systems may be installed in applications where the building is pre-existing, and they are retro-fitted to the space. Other times, luminaires are installed in a new construction application where the ceiling has yet to be installed/built. Other times the ceiling is already built and for ease of installation and maintenance later in life, the contractor may want to choose an option where the luminaire has easily accessible electronic components. In order to address the aforesaid problems and provide a safe, clean, and rigid method to maintain the electronics new solution is needed.

In construction of buildings, it is known to install false or suspended ceilings beneath water pipes, heating ducts and electrical races in order to easily access such structures while concealing them from normal activity within a building or room. Typically, the false ceiling is formed of acoustical tiles or drywall tiles which are supported by a network of inverted T-shaped grid members. The T-grid members are supported from the building structure by a plurality of wires or stems and are typically formed of lightweight, small gauge sheet steel. Such construction minimizes the cost of the grid members, provides adequate structural support for the ceiling tiles, and allows adequate access to mechanicals.

It would be desirable to design a means which is mountable in a T-grid system that allows for a large variety of electrical component to be installed external to the fixture utilizing the open space of a drop ceiling.

### SUMMARY OF THE INVENTION

This invention is a design for a grid hanger bar mounting bracket assembly for luminaire electrical/electronic components comprising a bracket with a clip and platform. The clip includes at least two prongs that attach to or are inserted on one grid hanger bar, for example a T-bar grid. A fastener extending through at least the one prong of the clip and engages the grid hanger bar to secure the bracket to the one grid hanger bar. The mounting bracket assembly further comprises a platform supported by the bracket, wherein the platform include a plurality of electrical component attachment points. This platform allows for a large variety of electrical component to be installed external to the luminaire utilizing the open space or plenum of a drop ceiling or wall and the one grid hanger bar.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1 illustrates a perspective view of the mounting bracket assembly attached to a grid hanger bar and a first electrical component attached thereto;

FIG. 2 illustrate a cross sectional view of the mounting bracket assembly attached to a grid hanger bar and an electrical component attached thereto;

FIG. 3 illustrates a perspective view of the mounting bracket assembly attached to a grid hanger bar and a second electrical component attached thereto;

FIG. 4 illustrates are side views of the snap-in clip and fastener attached to a grid hanger bar; and

FIG. 5, illustrates a detailed perspective view of a portions of the mounting bracket assembly.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described. In particular, the following discussion relates primarily to a molded grommet comprising input electrical wires and a vent tube for use in the installation of an outdoor luminaire. The invention is not so limited as other embodiments are contemplated by the invention.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

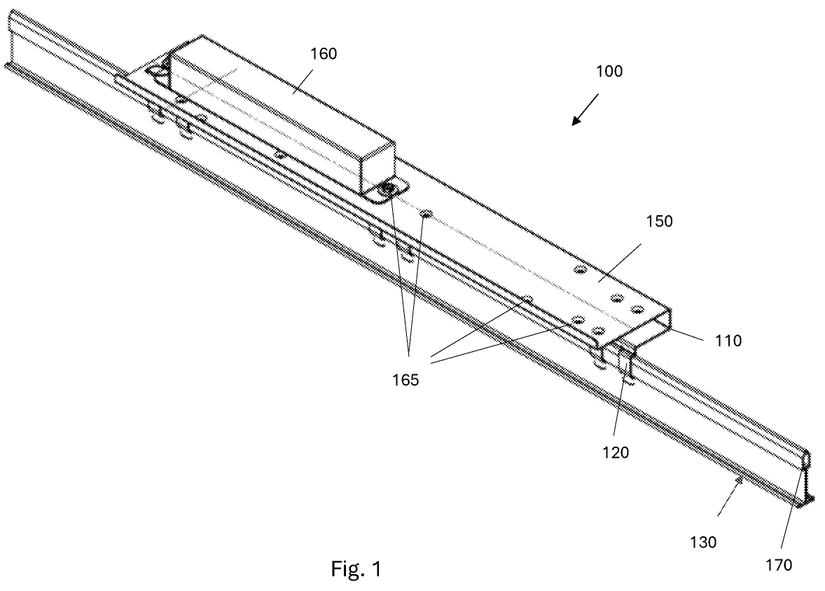

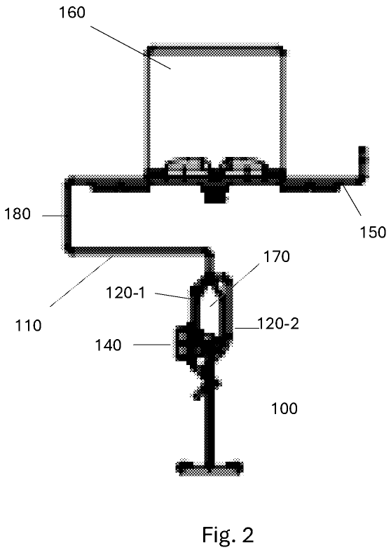

FIGS. 1 and 2 shows a grid hanger bar mounting bracket assembly 100 for luminaire electrical components in accordance with one embodiment of the present invention, attached to one grid bar of ceiling grid system, such as a T-bar grid. The mounting bracket assembly 100 comprises a bracket 110 with a clip 120. The clip 120 may include multiple prongs (120-1, 120-2), that attach or are inserted on top a grid bar 130, on either side of the grid bar 130, as shown inf FIG. 2. The grid bar mounting bracket assembly further comprises a platform 150 coupled/configured above the brackets 110 (two or more brackets 110 may be used), wherein the platform 150 has a plurality of electronic component attachment points 165. This platform 150 allows for a large variety of electrical components 160 to be installed external to the luminaire (not shown) utilizing the open space or plenum of a drop ceiling and the one grid hanger bar.

As shown in FIG. 1, the first prong (or multiple first prongs, as shown in FIG. 1) of clip 120 is first pushed or clipped onto a first side or portion 170 of the hanger grid bar. Thereafter, as further described below, the fastener 140 is coupled to the other side or portion of the hanger grid bar and secures the clip 120 to the hanger grid bar 130. The fastener 140 can be one or more of a screw, clip, grommet, spring clip, tape, Velcro, etc. As shown in FIG. 1, one or more clips 120 can be used.

In the embodiment illustrated in FIG. 1, the electrical component 160 is attached to two are more of the attachment points 165. The electrical component 160 can be coupled to the platform 150 using screws, clips, grommets, spring clips, tape, Velcro, etc. As discussed below, other types of electrical component sizes and types that require different attachment points are contemplated by the invention.

The mounting bracket assembly 100 shown which define portions of the bracket 110 and platform 150. The figures depict these elements for purpose of clarity. However, it should be understood by one skilled in the art that an oppositely directed bracket 110 and platform 150 can be formed of the same elements. The platform 150 shown is substantially horizontal, however the platform may be biased or angled depending on the plenum space or structure of the grid hanging bar.

The bracket 110 and platform 150 are also spaced apart from each other (depieced by element 180 in FIG. 2) to allow access to attach the electrical component 160 to the platform using additional fasteners, e.g. screws, clips, grommets, spring clips, tape, Velcro, etc., noted above. In addition, the spacing provides a gap between the platform 150 and the hanger grid bar 130 such that they do not interfere with each other. As shown in FIG. 1, the bracket 110 and platform 150 may centered above the vertical axis of the of the hanging grid bar 130. However, the bracket 110 and platform 150 may also be off set from the vertical axis of the hanging grid bar 130 such that they (or any fasteners) are not aligned and will not interfere with the attachment or adjustment of other elements generally attached to the hanger grid bar. The term offset should be understood as referencing a substantially vertical axis extending through the hanging grid bar 130. The platform 150 may also be completely on one side of the vertical axis of the hanging grid bar 130 (now shown).

As noted above, the platform 150 includes a plurality of electronic component attachment points 165. The attachment points 165 may be a plurality of holes, apertures or slots. The holes, apertures or slot allow for alternate mounting options or for pass-through of alternate fastening hardware. The attachment points 165 may also be configured to allow pass-through access for wiring, antennas, and other connection points any for luminaire accessories, e.g. sensors, switches, etc.

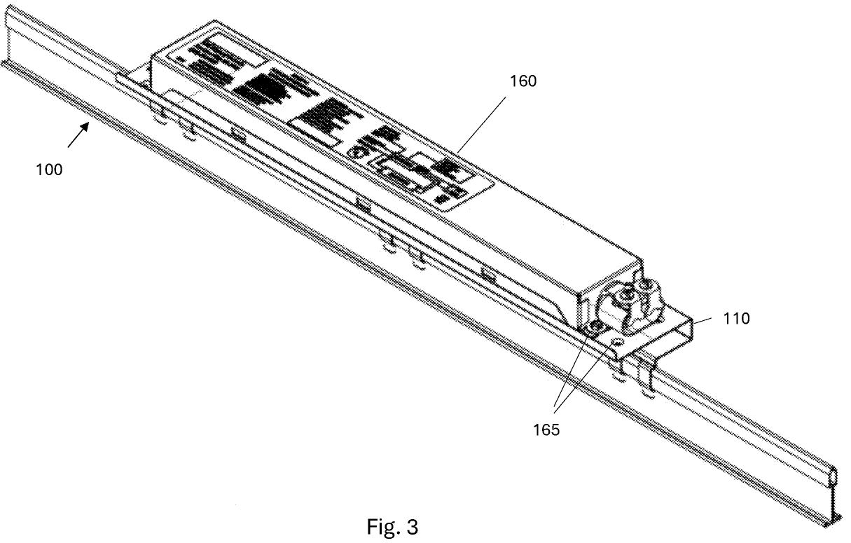

The plurality of electrical component attachment points 165 include a first set of attachment points 165 to enable a first electoral component 160 to be attached to the platform 150, as shown in FIG. 1. The plurality of electronic component attachment points 160 include a second set of attachment points 165 to enable a second electoral component 160 to be attached to the platform 150, as shown in FIG. 3. A variety of electoral components 160 are contemplated to be attached to the platform 150 using different sets of attachment points 165. In addition, two or more electrical components 160 may be attached to the platform 150 simultaneously.

FIG. 2 illustrate a cross sectional view of the invention attached to a grid hanger bar and an electrical component attached thereto. In FIG. 2, the first prong 120-1 of clip 120 is first pushed or clipped onto a first side or portion 170 of the hanger grid bar. Thereafter an installer attaches the second prong 120-2 of clip 120 to the other side or portion of the hanger grid bar and secures both the first prong 120-1 and second prong 120-2 together to the hanger grid bar 130 with fastener 140.

Likewise, the bracket 110 and/or clip 120 may be adjustable for use with wooden joists. For example, fastener 140 may be hammered or struck so as to engage a wood joist or wood ceiling structure. The first and second prongs 120-1 and 120-2 may provide a sharp initial engagement feature for the bracket clip 120 to engage a wood joist.

FIG. 3 shows a grid hanger bar mounting bracket assembly 100 for a second type of luminaire electrical component in accordance with the embodiment of the present invention, attached to one grid bar of a ceiling grid system, such as a T-bar grid. In the embodiment illustrated in FIG. 3, the electrical component 160 is attached to two are more of the attachment points 165, that are different than in FIG. 1.

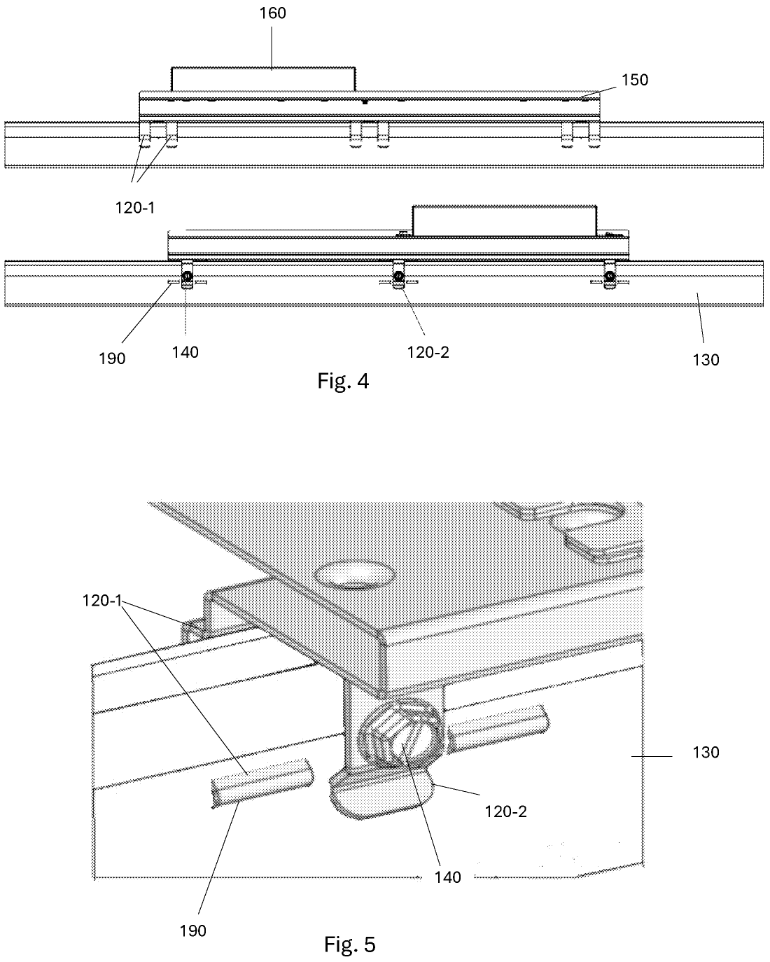

FIG. 4 illustrates side views of the clip and fastener attached to a grid hanger bar. As shown in FIG. 4, multiple clips 120 are used, each having three prongs, e.g. first prongs 120-1 and second prong(s) 120-2. The first prongs 120-1 are coupled to a first side of the grid bar 130 and the second prongs 120-2 positioned on the second side of grid hanger bar 130. Prong 120-2 also secures the clip 120 to the grid bar 130 using fastener 140. Slots 190 can also be used to clip one or more of the prongs 120-1 or 120-2 to the grid bar 130.

FIG. 5, illustrates a detailed perspective view of a portions, in particular clip 120, of the mounting bracket assembly. As shown in FIG. 5, two first prongs 120-1 of clip 120 are inserted into slots 190 provided in the grid hanger bar 130. One second prong 120-2 is correspondingly aligned on a second side of grid hanger bar 130 and a fastener 140, for example a screw, is used in conjunction with (screwed into) the second prong 120-2 to secure the clips 120 to the grid hanger bar 130, wherein the fastener 140 engages the grid hanger bar 130 to secure the bracket assembly 100.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components (devices, systems, and the like), the terms (including a reference to a "means") used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

1. A T-grid mounting bracket assembly for a luminaire’s electrical components , the mounting bracket assembly comprising:
two or more brackets with a clip, wherein the clip includes one or more prongs that attach to or are inserted on a single T-grid hanger bar, and wherein a first prong is positioned or clipped on a first side of the T-grid hanger bar;
a fastener coupled to the first prong of the clip and engaging the T-grid hanger bar to secure the two or more brackets to the single T-grid hanger bar;
a platform supported by the two or more brackets and configured above the single T-grid hanger bar, wherein the platform includes a plurality of electrical component attachment points to enable attachment of a first electrical component to a first set of attachment points and/or a second electrical component to a second set of attachment points to be installed external to the luminaire utilizing open space or plenum above a ceiling or within a wall and the single T-grid hanger bar.

2. The T-grid mounting bracket assembly according to claim 1, wherein the clip further includes a second prong positioned on a second side of the one grid hanger bar.

3. The T-grid mounting bracket assembly according to claim 1, wherein the two or more brackets and platform are spaced apart from each other to allow access to attach the electrical component to the platform.

4. The T-grid mounting bracket assembly according to claim 1, wherein the attachment points of the platform are off-set from a vertical axis of the hanging grid bar such that they are not aligned.

5. The T-grid mounting bracket assembly according to claim 1, wherein the attachment points holes, apertures, slots, spring or clip-in mechanisms.

6. The T-grid mounting bracket assembly according to claim 1, wherein fastener is one or more of a screw, screws, clips, grommets, spring clips, tape, and Velcro.

7. The T-grid mounting bracket assembly according to claim 1, wherein the first prong is configured to clip into slots on the first side of the T-grid hanger bar .
